(19) United States
(12) Patent Application Publication
(10) Pub. No.: US 2018/0176465 A1
(43) Pub. Date: Jun. 21, 2018

(54) IMAGE PROCESSING METHOD FOR IMMEDIATELY PRODUCING PANORAMIC IMAGES

(71) Applicant: PROLIFIC TECHNOLOGY INC., Taipei City (TW)

(72) Inventors: GUAN-YU CHEN, Taipei City (TW); HSIN-YUEH CHANG, Taipei City (TW)

(21) Appl. No.: 15/381,110

(22) Filed: Dec. 16, 2016

(51) Int. Cl. H04N 5/232; G06T 7/80; G06T 11/60

(52) U.S. Cl. CPC H04N 5/23238; H04N 5/23222; G06T 2207/20221; G06T 11/60; G06T 2207/10004; G06T 7/80

(57) ABSTRACT

The present invention provides an image processing method for immediately producing panoramic images. In this method, two fish-eye cameras are used for capturing video information, and then, a streaming video is transmitted to an electronic device by wired or wireless technology after the video information is treated with a video encoding process and a streaming process. Therefore, an image processing application program installed in the electronic device is able to subsequently treat the streaming video with a video encoding process, a panoramic coordinates converting process, an image stitching process, and an edge-preserving smoothing process in turns, so as to eventually show a sphere panorama on the display of the electronic device. Moreover, by the utilization of a digital signal processor, the image processing application program is able to further process the sphere panorama to a plain panorama, a fisheye panorama, or a human-eye panorama.

### BACKGROUND OF THE INVENTION

### 1. Field of the Invention

The present invention relates to the image processing technology field, and more particularly to an image processing method for immediately producing panoramic images.

### 2. Description of the Prior Art

Because traditional film cameras just can capture scenes by a capture angle in a range from 30° to 50°, the traditional film cameras cannot capture panoramic scenes in one single picture. Recently, with the emergence of digital cameras and the advance of image processing technologies, conventional photography technologies have been able to use multi camera lens to capture the panoramic scenes by an entire angular image capturing range, such that the panoramic scenes can be processed to a 360 degree panoramic image presented on a single picture by using a multiple image stitch processing technology.

Please refer to FIG. 1, which illustrates a flow chart of a conventional image processing method for producing 360 degree panoramic images. As shown in FIG. 1, the conventional image processing method consists of following steps:
step (S1′): using a plurality of camera devices to capture a plurality of image frames;
step (S2′): changing point coordinates of the image frames to a plurality of spherical coordinates on a semispherical plane;
step (S3′): changing the image frames to a plurality of latitude-longitude images by latitude-longitude projection method;
step (S4′): treating the image frames with an optical clipping process, and then stitching the image frames to a plurality of panoramic image frames;
step (S5′): treating the panoramic image frames with an edge smoothing process;
step (S6′): treating each of the panoramic image frames with a video coding process in a time series of the image frames, such that a panoramic video is produced and then outputted.

Although the conventional image processing method for producing 360 degree panoramic images is now widely practiced in a form of App (application software), inventors of the present invention find that the conventional image processing method still includes some drawbacks and shortcomings in practical application. The drawbacks are summarized as following two points:
(1) It must ensure that each of two adjacent image frames have an image overlapping region when using the camera devices to capture the image frames based on a common optical center. Obviously, it seems that the practical application of the conventional image processing method has many limitations.
(2) Because all the camera devices are a wide-angle lens such as fish-eye lens, it needs to treat the image frames with a distortion correction of the fish-eye lens before stitching the image frames to the panoramic image frames. So that, as the engineers skilled in image processing technology field know, image processing hardware must complete the image processes of 24-30 image frames in 1 second if it wants to produce a smoothly-playing panoramic video; however, such image processing works does not only exceedingly burn the calculation resources of the image processing hardware, but also over the load efficiency of the image processing hardware. Based on above reason, the engineers skilled in image processing technology field can easily assume that the conventional image processing method cannot produce a real-time panoramic video.

Accordingly, in view of the conventional image processing method showing many drawbacks and shortcomings in practical applications, the inventors of the present application have made great efforts to make inventive research thereon and eventually provided an image processing method for immediately producing panoramic images.

### SUMMARY OF THE INVENTION

The primary objective of the present invention is to provide an image processing method for immediately producing panoramic images. Differing from conventional image processing technology cannot immediately produce 360 degree panoramic images, the present invention particularly provides an image processing method for immediately producing panoramic images. In this method, two fish-eye cameras are used for capturing video information, and then, a streaming video is transmitted to an electronic device by wired or wireless technology after the video information is treated with a video encoding process and a streaming process. Therefore, an image processing application program installed in the electronic device is able to subsequently treat the streaming video with a video encoding process, a panoramic coordinates converting process, an image stitching process, and an edge-preserving smoothing process in turns, so as to eventually show a sphere panorama on the display of the electronic device. Moreover, by the utilization of a digital signal processor, the image processing application program is able to further process the sphere panorama to a plain panorama, a fisheye panorama, or a human-eye panorama.

In order to achieve the primary objective of the present invention, the inventor of the present invention provides an embodiment for the image processing method for immediately producing panoramic images, which is applied in an electronic device and comprises following steps:
(1) treating at least one image capturing module with a parameter calibration process;
(2) using the at least one image capturing module to capture at least two image frames;
(3) treating the at least two image frames with a panoramic coordinates conversing process, so as to produce at least two panoramically-coordinated image frames;
(4) treating the at least two panoramically-coordinated image frames with an image stitching process, so as to obtain a single panoramic image frame; and
(5) treating the panoramic image frame with a display mode conversing process in order to make the panoramic image frame be shown on a display of the electronic device by a specific display mode.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a flow chart of a conventional image processing method for producing 360 degree panoramic images;

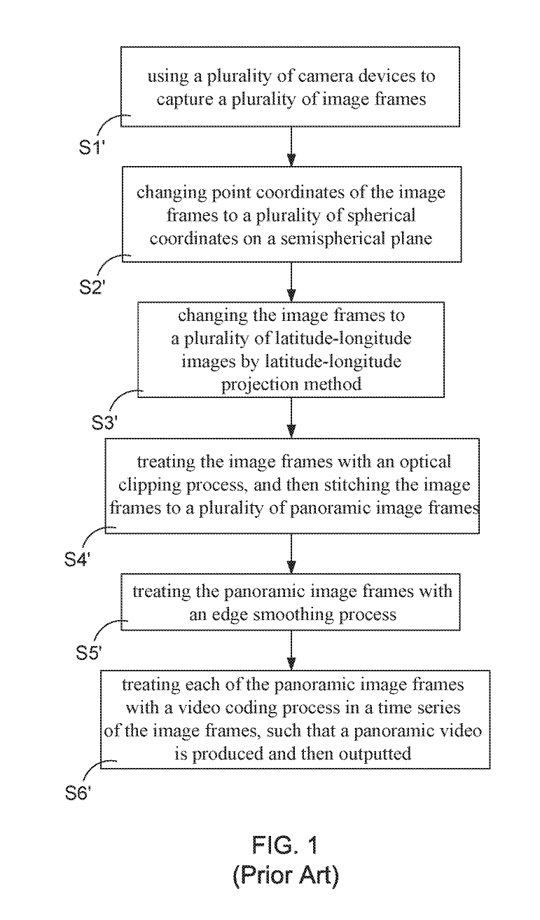

FIG. 2 shows a flow chart of an image processing method for immediately producing panoramic images according to the present invention;

FIG. 3 shows a schematic operation diagram of using a panoramic camera to capture image frames;

FIG. 4 shows two image frames captured by a left fisheye lens and a right fisheye lens;

FIG. 5 shows a sphere panorama of a single panoramic image frame under a spherical panoramic display mode;

FIG. 6 shows a plain panorama of the single panoramic image frame under a plain panoramic display mode.

### DETAILED DESCRIPTION OF THE PREFERRED EMBODIMENTS

To more clearly describe an image processing method for immediately producing panoramic images according to the present invention, embodiments of the present invention will be described in detail with reference to the attached drawings hereinafter.

The image processing method for immediately producing panoramic images proposed by the present invention can be applied in an electronic device such as digital camera, smart phone, tablet PC, or notebook by a form of App (application software). Thus, after a user completes an image capturing operation (or a video recording operation) by using an image capturing module, the App would immediately transform an image captured by the image capturing operation (or a plurality of image frames obtained from the video recording operation) to a panoramic image (or a panoramic video).

It is worth explaining that, the aforesaid image capturing module can be an independent camera device or a camera module of the electronic device. Moreover, the image frames are transmitted from the image capturing module to the electronic device by wired transmission technology or wireless transmission technology. On the other hand, as engineers skilled in image processing technology field know, both the terms of “one frame of image” and “an image frame” mean one photograph, and a video or video stream consists of a plurality of image frames.

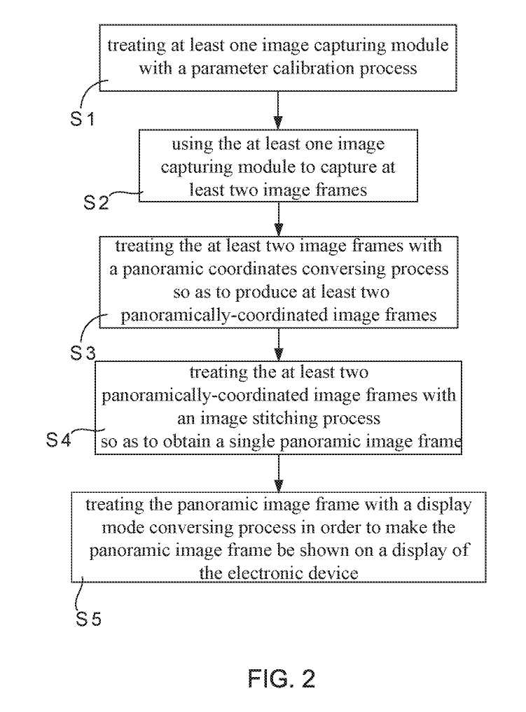

Please refer to FIG. 2, where a flow chart of an image processing method for immediately producing panoramic images according to the present invention is provided. As FIG. 2 shows, the image processing method of the present invention mainly comprises 5 processing steps.

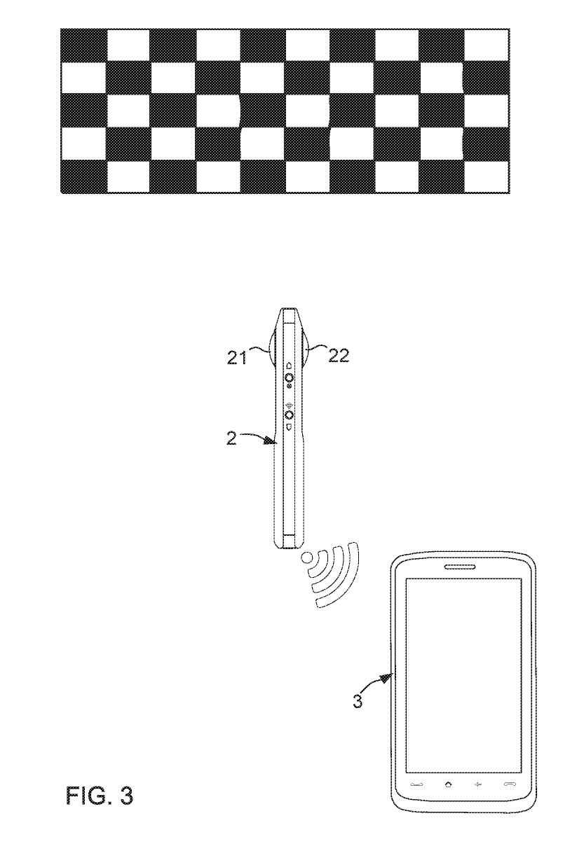

First of all, the method proceeds to step (1) for treating at least one image capturing module with a parameter calibration process. FIG. 3 shows a schematic operation diagram of using a panoramic camera to capture image frame. From FIG. 3, it is able to know that a commercial panoramic camera includes a left fisheye lens 21 and a right fisheye lens 22 for respectively capturing 360-degree horizontal panoramic images and 360-degree vertical panoramic images. So that, the parameter calibration process of the image capturing modules is carried out in the step (1) by using a mathematical equation defined as

$$\frac{F O V}{180} = \frac{2 W}{( 2 W - {W}_{over} )} .$$

In the mathematical equation, FOV means the field of view of the image capturing module, and W and Wₒᵥₑᵣ represent an image width and an image overlapping width of two of the image frames, respectively.

After the step (1) is completed, the method continuously proceeds to step (2) for using the at least one image capturing module to capture at least two image frames. Subsequently, the method proceeds to step (3) for treating the at least two image frames with a panoramic coordinates conversing process, so as to produce at least two panoramically-coordinated image frames. Herein, it needs to further explain that, although FIG. 3 shows that the two image frames are respectively capture by the left fisheye lens 21 and the right fisheye lens 22, that does not used for limiting the practice way of the step (2), the two image frames can also be captured by using one single image capturing module in practical application.

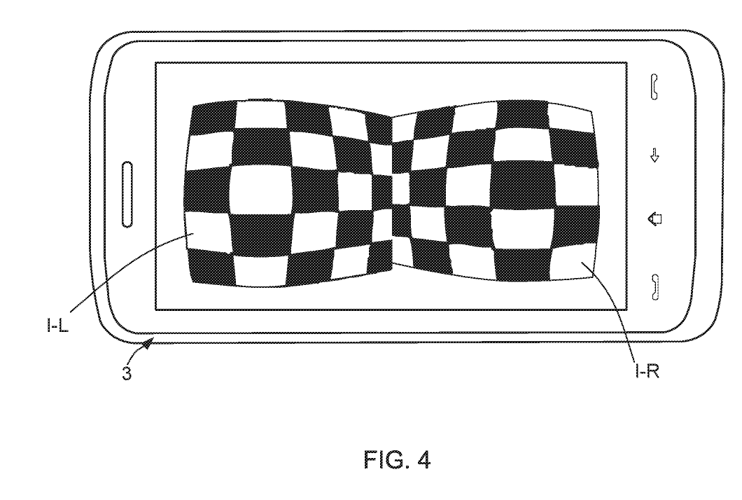

Please refer to FIG. 4, which illustrates shows two image frames captured by the left fisheye lens and the right fisheye lens. As FIG. 3 and FIG. 4 show, after an L-frame wide-angle image captured by the left fisheye lens 21 and an R-frame wide-angle image captured by the right fisheye lens 22, the panoramic camera 2 immediately treats the two wide-angle images with an image (or a video) encoding process and a streaming process, and then transmits an image (or a video) stream to the electronic device 3 installed with the App of the present invention by wired or wireless technology. Furthermore, in the step (3), the two image frames are firstly treated with a latitude-longitude coordinate conversing process by using two coordinate conversion formulas defined as follows:

$$\begin{matrix}θ = PI \times ( \frac{X}{W} - 0.5 ) & ( 1 ) \\ ∅ = PI \times ( \frac{Y}{H} - 0.5 ) & ( 2 )\end{matrix}$$

A plurality of latitude-longitude coordinates are obtained after the latitude-longitude coordinate conversing process is completed. It needs to explain that, (θ, Ø) shown in the coordinate conversion formulas represents a latitude-longitude coordinate; moreover, PI, W and H represent a circumference ratio, an image width and an image height, respectively. Furthermore, the latitude-longitude coordinates are subsequently treated with a 3D vector conversing process in order to produce a plurality of 3D vectors, wherein the 3D vector conversing process is carried out by using three vector conversion formulas defined as follows:

spX=cos Ø×sin θ (3)

spY=cos Ø×cos θ (4)

spZ=sin Ø (5)

In above-presented three vector conversion formulas, (θ, Ø) and (spX, spY, spZ) represent a latitude-longitude coordinate and a 3D vector coordinate, respectively. Continuously, the obtained 3D vectors are treated with a projection conversing process for producing a plurality of projected latitude-longitude coordinates, wherein the projection conversing process is carried out by using three conversion formulas defined as follows:

$$\begin{matrix}{θ}^{*} = {tan}^{- 1} ( \frac{spZ}{spX} ) & ( 6 ) \\ {∅}^{*} = {tan}^{- 1} ( \frac{\sqrt{( spX \times spX ) + ( spZ \times spZ )}}{spY} ) & ( 7 ) \\ r = \frac{W \times {∅}^{*}}{F O V} & ( 8 )\end{matrix}$$

In the three conversion formulas, (r, θ*, Ø*) and (spX, spY, spZ) represent a projected latitude-longitude coordinate and a 3D vector coordinate, respectively; moreover, FOV means the field of view of the image capturing module and W representing an image width. Eventually, two calculation formulas are used to calculate a plurality of original image coordinates of the at least two image frames based on the projected latitude-longitude coordinates, such that the at least two panoramically-coordinated image frames are hence produced. The two calculation formulas are defined as follows:

X*=Cx+r×cos θ* (9)

Y*=Cy+r×sin θ* (10)

In the two calculation formulas, (X*, Y*) and (Cx, Cy) represent a panorama coordinate and a lens center coordinate of the fisheye lens obtained after the parameter calibration process is finished.

After the step (3) is completed, the method continuously proceeds to step (4) for treating the at least two panoramically-coordinated image frames with an image stitching process, so as to obtain a single panoramic image frame. To completing the step (4), it needs to firstly select a first sub-region from an image overlapping region of the two panoramically-coordinated image frames. That is, selecting a left sub-region from an image overlapping region locating in right side of the left side image frame of the two panoramically-coordinated image frames. Continuously, to find out a plurality of left feature points from the left sub-region by using a fixed interval sampling method, and subsequently find out a plurality of first feature-matching points from one of the two panoramically-coordinated image frames matching the left feature points by using a pattern recognition method.

After finding out the first feature-matching points, it needs to further select a second sub-region from an image overlapping region of the two panoramically-coordinated image frames. That is, selecting a right sub-region from an image overlapping region locating in left side of the right side image frame of the two panoramically-coordinated image frames. Continuously, to find out a plurality of right feature points from the right sub-region by using a fixed interval sampling method, and subsequently find out a plurality of second feature-matching points from another one of the two panoramically-coordinated image frames matching the right feature points by using a pattern recognition method.

After obtaining the first feature-matching points and the second feature-matching points, the App is able to stitch the two panoramically-coordinated image frames based on the first feature-matching points and the second feature-matching points, such that the panoramic image frame is produced. Furthermore, as the engineers skill in image processing technology field know, the panoramic image frame obtained by stitch the two panoramically-coordinated image frames must be subsequently treated with an edge smoothing process in order to eliminate stitch seam.

When executing the edge smoothing process, it needs to firstly find out the center point of the image overlapping region of the left side image frame and the right side image frame, and then use following mathematical equation to carry out a first image blending process.

$${P}_{L}^{′} = {P}_{L 0} \times \frac{{W}_{L 0}}{{W}_{L}} + {P}_{R} \times \frac{{W}_{L} - {W}_{L 0}}{{W}_{L}} \qquad ( 11 )$$

In above-presented mathematical equation, P_{L}′ represents a new pixel of the left side image frame of the two panoramically-coordinated image frames stitched to each other; moreover, P_{L0} and P_{R} represent the original pixel of the left side image frame and the original pixel of the right side image frame, respectively. In addition, W_{L} means a left width of the image overlapping region, and W_{L0} represents a distance from a specific pixel in the left side image frame to a left boundary of the left side image frame. After completing the first image blending process, a second image blending process is subsequently carried out by using a mathematical equation defined as follows:

$${P}_{R}^{′} = {P}_{R 0} \times \frac{{W}_{R 0}}{{W}_{R}} + {P}_{L} \times \frac{{W}_{R} - {W}_{R 0}}{{W}_{R}} \qquad ( 12 )$$

In above-presented mathematical equation, P_{R}′ represents a new pixel of the right side image frame of the two panoramically-coordinated image frames stitched to each other; moreover, P_{R0} and P_{L} represent the original pixel of the right side image frame and the original pixel of the left side image frame, respectively. In addition, W_{R} means a right width of the image overlapping region, and W_{R0} represents a distance from a specific pixel in the right side image frame to a right boundary of the right side image frame.

After the completing the image stitching process and the edge smoothing process, the method is continuously proceeded to step (5) for treating the panoramic image frame with a display mode conversing process in order to make the panoramic image frame be shown on a display of the electronic device 3 by a specific display mode, such as spherical panoramic display mode, plain panoramic display mode, fisheye panoramic display mode, human-eye panoramic display mode, or projection panoramic display mode. So that, the panoramic image frame can be shown on the display of the electronic device by a form of sphere panorama, plain panorama, fisheye panorama, human-eye panorama, or projection panorama. As the engineers skilled in image processing technology field know, the display mode conversing process is completed by using a programmable image processor or a digital signal processor. Besides, the display mode conversing process can also be completed by a programmable image processing library such as OpenGL® 1.5, DirectX®, or Shader Model 3.0 in built a display card of the electronic device 3.

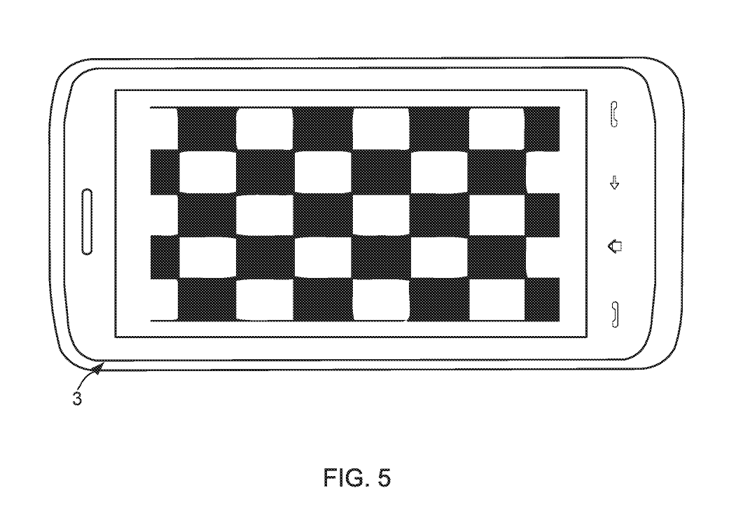

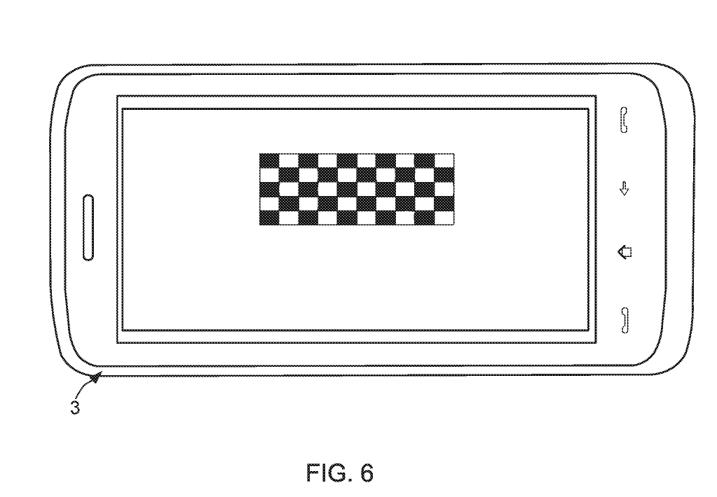

Referring to FIG. 4 again, and please simultaneously refer to FIG. 5 and FIG. 6, where a sphere panorama and a plain panorama of the single panoramic image frame are presented under a spherical panoramic display mode and a plain panoramic display mode, respectively. As FIG. 4 shows, an user can operate the electronic device 3 installed with the image processing App of the present invention to directly display an L-frame wide-angle image I-L captured by the left fisheye lens 21 and an R-frame wide-angle image I-R captured by the right fisheye lens 22. Moreover, as FIG. 5 shows, the user can also operate the electronic device 3 to converse the L-frame wide-angle image I-L and the R-frame wide-angle image I-R to a single panoramic image frame, and show a sphere panorama on the display of the electronic device 3. On the other hand, the user can also operate the electronic device 3 to converse the L-frame wide-angle image I-L and the R-frame wide-angle image I-R to one plain panoramic image frame, and show a plain panorama on the display of the electronic device 3.

Herein, it needs further explain that, above descriptions of the embodiment of the image processing method of present invention are made by taking one L-frame wide-angle image and one R-frame wide-angle image for examples. However, the image processing method of the present invention can also applied to process a video stream. For instance, after obtaining a plurality of panoramic image frames from the step (5), a panoramic video can be produced after treating each of the panoramic image frames with a video coding process in a time series of the image frames.

Therefore, through above descriptions, the waste air exhausting device having functionality to abate noise and modulate noise frequency provided by the present invention has been introduced completely and clearly; in summary, the present invention includes the advantages of:

(1) Differing from conventional image processing technology cannot immediately produce 360-degree panoramic images, the present invention provides an image processing method for immediately producing panoramic images. In this method, two fish-eye cameras been calibrated are used for capturing video information; and then, after treating the video information with a video encoding process and a streaming process, streaming video is transmitted to an electronic device by wired or wireless way. Therefore, an image processing application program installed in the electronic device can be used for treating the streaming video with a video encoding process, a panoramic coordinates converting process, an image stitching process, and an edge-preserving smoothing process, so as to eventually show a sphere panorama on the display of the electronic device. Moreover, by using a programmable image processor or a digital signal processor, the image processing application program is able to show a plain panorama, a fisheye panorama, or a human-eye panorama on the display of the electronic device after treating the sphere panorama with a visual field converting process.

The above description is made on embodiments of the present invention. However, the embodiments are not intended to limit scope of the present invention, and all equivalent implementations or alterations within the spirit of the present invention still fall within the scope of the present invention.

What is claimed is:

1. An image processing method for immediately producing panoramic images, being applied in an electronic device and comprising following steps:
(1) treating at least one image capturing module with a parameter calibration process;
(2) using the at least one image capturing module to capture at least two image frames;
(3) treating the at least two image frames with a panoramic coordinates conversing process, so as to produce at least two panoramically-coordinated image frames;
(4) treating the at least two panoramically-coordinated image frames with an image stitching process, so as to obtain a single panoramic image frame; and
(5) treating the panoramic image frame with a display mode conversing process in order to make the panoramic image frame be shown on a display of the electronic device by a specific display mode.

2. The image processing method of claim 1, wherein the specific display mode is selected from the group consisting of: spherical panoramic display mode, plain panoramic display mode, fisheye panoramic display mode, human-eye panoramic display mode, and projection panoramic display mode.

3. The image processing method of claim 1, wherein the parameter calibration process is carried out in the step (1) by using a mathematical equation defined as follows:
$$\frac{F O V}{180} = \frac{2 W}{( 2 W - {W}_{over} )} ;$$
wherein FOV means the field of view of the image capturing module, and W and Wₒᵥₑᵣ representing an image width and an image overlapping width of two of the image frames, respectively.

4. The image processing method of claim 1, wherein the step (3) comprises following detail steps:
(31) treating the at least two image frames with a latitude-longitude coordinate conversing process, so as to obtain a plurality of latitude-longitude coordinates;
(32) treating the latitude-longitude coordinates with a 3D vector conversing process, and then producing a plurality of 3D vectors;
(33) treating the 3D vectors with a projection conversing process so as to obtain a plurality of projected latitude-longitude coordinates; and
(34) calculating a plurality of original image coordinates of the at least two image frames based on the projected latitude-longitude coordinates, such that the at least two panoramically-coordinated image frames are produced.

5. The image processing method of claim 1, wherein the display mode conversing process is completed by using a programmable image processor or a digital signal processor.

6. The image processing method of claim 1, wherein the electronic device is selected from the group consisting of: digital camera, smart phone, tablet PC, and notebook.

7. The image processing method of claim 1, wherein the image frames are transmitted from the at least one image capturing module to the electronic device by wired transmission technology or wireless transmission technology.

8. The image processing method of claim 1, wherein the step (4) comprises following detail steps:
(41) selecting a sub-region from an image overlapping region of the two panoramically-coordinated image frames;
(42) finding out a plurality of feature points from the sub-region by using a fixed interval sampling method;
(43) finding out a plurality of first feature-matching points from one of the two panoramically-coordinated image frames matching the feature points by using a pattern recognition method;
(44) repeating the step (42), an then using the pattern recognition method to find out a plurality of second feature-matching points from the other one of the two panoramically-coordinated image frames matching the feature points;
(45) stitching the two panoramically-coordinated image frames based on the first feature-matching points and the second feature-matching points, such that the panoramic image frame is produced; and
(46) treating the panoramic image frame with an edge smoothing process.

9. The image processing method of claim 1, wherein the image capturing module is disposed with at least one fisheye lens.

10. The image processing method of claim 7, wherein the latitude-longitude coordinate conversing process is carried out in the step (31) by using two coordinate conversion formulas defined as follows:
$$\begin{matrix}θ = PI \times ( \frac{X}{W} - 0.5 ) ; and & ( 1 ) \\ ∅ = PI \times ( \frac{Y}{H} - 0.5 ) ; & ( 2 )\end{matrix}$$
wherein (θ, Ø) represents a latitude-longitude coordinate, and PI, W and H representing a circumference ratio, an image width and an image height, respectively.

11. The image processing method of claim 7, wherein the 3D vector conversing process is carried out in the step (32) by using three vector conversion formulas defined as follows:
spX=cos Ø×sin θ (3);
spY=cos Ø×cos θ (4); and
spZ=sin Ø (5);
wherein (θ, Ø) and (spX, spY, spZ) represent a latitude-longitude coordinate and a 3D vector coordinate, respectively.

12. The image processing method of claim 7, wherein the projection conversing process is carried out in the step (33) by using three conversion formulas defined as follows:
$$\begin{matrix}{θ}^{*} = {tan}^{- 1} ( \frac{spZ}{spX} ) ; & ( 6 ) \\ {∅}^{*} = {tan}^{- 1} ( \frac{\sqrt{( spX \times spX ) + ( spZ \times spZ )}}{spY} ) ; and & ( 7 ) \\ r = \frac{W \times {∅}^{*}}{F O V} ; & ( 8 )\end{matrix}$$
wherein (r, θ*, Ø*) and (spX, spY, spZ) represent a projected latitude-longitude coordinate and a 3D vector coordinate, respectively; moreover, FOV meaning the field of view of the image capturing module and W representing an image width.

13. The image processing method of claim 10, wherein the original image coordinates are calculated in the step (34) by using two calculation formulas defined as follows:
X*=Cx+r×cos θ* (9); and
Y*=Cy+r×sin θ* (10);
Wherein (X*, Y*) and (Cx, Cy) represent a panorama coordinate and a lens center coordinate obtained after the parameter calibration process is finished.

14. The image processing method of claim 7, wherein the step (46) comprises following detail steps:
(461) finding out a center point of the image overlapping region;
(462) treating one of the two panoramically-coordinated image frames with a first image blending process; and
(463) treating the other one of the two panoramically-coordinated image frames with a second image blending process.

15. The image processing method of claim 14, wherein the first image blending process is carried out in the step (462) by using a mathematical equation defined as follows:
$${P}_{L}^{′} = {P}_{L 0} \times \frac{{W}_{L 0}}{{W}_{L}} + {P}_{R} \times \frac{{W}_{L} - {W}_{L 0}}{{W}_{L}} ;$$
wherein:
P_{L0} representing the original pixel of a left side image frame of the two panoramically-coordinated image frames stitched to each other;
P_{R} representing the original pixel of a right side image frame of the two panoramically-coordinated image frames stitched to each other;
P_{L}′ representing a new pixel of the left side image frame of the two panoramically-coordinated image frames stitched to each other;
W_{L} representing a left width of the image overlapping region;
W_{L0} representing a distance from a specific pixel in the left side image frame to a left boundary of the left side image frame.

16. The image processing method of claim 14, wherein the second image blending process is carried out in the step (463) by using a mathematical equation defined as follows:
$${P}_{L}^{′} = {P}_{L 0} \times \frac{{W}_{L 0}}{{W}_{L}} + {P}_{R} \times \frac{{W}_{L} - {W}_{L 0}}{{W}_{L}} ;$$
wherein:
P_{R0} representing the original pixel of a right side image frame of the two panoramically-coordinated image frames stitched to each other;
P_{L} representing the original pixel of a left side image frame of the two panoramically-coordinated image frames stitched to each other;
P_{R}′ representing a new pixel of the right side image frame of the two panoramically-coordinated image frames stitched to each other;
W_{R} representing a right width of the image overlapping region;
W_{R0} representing a distance from a specific pixel in the right side image frame to a right boundary of the right side image frame.
